(19) United States
(12) Patent Application Publication
(10) Pub. No.: US 2009/0325439 A1
(43) Pub. Date: Dec. 31, 2009

(54) POLYESTER FIBER, AND FABRIC COMPRISING THE SAME

(76) Inventors: Yun-Jo Kim, Gyeongsangbuk-do (KR); Young-Soo Lee, Chungchungbuk-do (KR)

Correspondence Address: SUGHRUE MION, PLLC, 2100 PENNSYLVANIA AVENUE, N.W., SUITE 800, WASHINGTON, DC, 20037, US

(21) Appl. No.: 12/528,226

(22) PCT Filed: Mar. 5, 2008
(86) PCT No.: PCT/KR08/01254

§ 371 Date: Aug. 21, 2009

(30) Foreign Application Priority Data
Mar. 5, 2007 (KR) 10-2007-0021632
Mar. 9, 2007 (KR) 10-2007-0023559

(51) Int. Cl. D02G 3/02; D01F 6/62; B32B 5/02

(52) U.S. Cl. 442/60; 428/397; 428/221

(57) ABSTRACT

The present invention relates to a polyester fiber with surface smoothness that is maximized by making the cross-section of the filaments flat and uniform, and fabric made of the present fibers is thinner than fabric made of the circular cross-sectional fibers, so it is possible to reduce the amount of coating resin used and to lighten the weight of the product because of low surface irregularity and porosity, and a fabric including the same.

### CROSS REFERENCES TO RELATED APPLICATION

This application claims priority to and the benefit of Korean Patent Application No. 10-2007-0021632 filed in the Korean Industrial Property Office on Mar. 5, 2007 and No. 10-2007-0023559 filed in the Korean Industrial Property Office on Mar. 9, 2007, which are hereby incorporated by reference for all purpose as if fully set forth herein.

### BACKGROUND OF THE INVENTION

(a) Field of the Invention

The present invention relates to a polyester fiber and a fabric comprising the same.

(b) Description of the Related Art

General monofilament fibers have a circular cross-section. Such monofilament fibers having a circular cross-section are generally used in a form of twisted yarns or in a form of fabric made of the yarns.

However, in a case of preparing fabrics by using the circular cross-sectional fibers, there is a limitation in that the fabric is inappropriate for a transfer fabric for a signboard and the like, on which resins or paints are coated, because the fabric is thick and has high surface roughness and low flatness.

To resolve such problems, prior techniques have induced to spread the fibers by lowering the cohesion factor thereof in a spinning process to improve smoothness of the final fabric. In this case, however, troubles such as, the occurrence of failing to catch some filament of bundle, a bad winding package due to a slip of filament bundle, etc., are caused in a winding process, the yield of the process is reduced because of deterioration of the cohesion factor of the fibers, and there is a limitation in that quality of the product is deteriorated in the weaving process because the fibers catch in guides because of the decrease of the cohesion factor of the fibers and because of the generation of fluffs caused by friction.

To overcome such limitations, Korean Patent Publication No. 2004-0011724 discloses monofilament fibers having a tetragonal cross-section. However, the publication merely defines the shape of the cross-section of the fibers, and it does not provide any practical examples for preparing the tetragonal cross-section fibers.

To improve such problems of the prior techniques, the present applicant has provided polyester fibers having a flatness of 1.2 to 5.5, a birefringence index of 0.205 or more, and a crystallinity of 45% or more, and disclosed that it is possible to prepare thin fabrics having good smoothness by using the same in Korean Patent Publication No. 2004-0100577. However, the publication only mentions the flatness as a rate of the long axis to the short axis of the cross-section of the fiber, and it does not mention the concrete shape of shoulder parts of the cross-section that substantially influence the properties of the fiber.

Further, the present applicant has disclosed a polyester fiber having a flat cross-section of which the cohesion factor is not deteriorated while having good smoothness by providing uniform interminglement to the fiber with a multi-step interlacer, in Korean Patent Publication No. 2006-0089858. However, the publication just discloses the flatness of the fiber, and it does not mention the concrete shape of the shoulder parts of the cross-section that influence the properties of the fiber.

Since such shape and uniformity of the cross-section of the fiber influence the properties and the smoothness of the fiber, it is important to secure cross-sectional uniformity, and, particularly, it is more effective when the shape of the cross-section has a flat form.

Previous methods for preparing industrial polyester fibers may be divided into two main methods of a direct spinning-drawing (DSD) method and a warp-drawing (W/D: Warp Drawer, wherein undrawn fibers are drawn in a warp direction) method.

The DSD method is a direct spinning and drawing method in which the spinning process and the drawing process are directly linked, and the fiber is prepared by passing undrawn fiber that is spun from a die of a spinning part through drawing and relaxing processes in rollers, wherein the spinning, the drawing, and the relaxing processes are performed in connection with one processor.

The W/D method is divided into a process for preparing an undrawn fiber and a process for preparing a drawn fiber, and the method prepares a fiber by carrying out the drawing and relaxing processes in a warp drawer after preparing undrawn fiber.

In the DSD process, an interlacer is used for intermingling the polyester fibers, and the cohesion factor is generally controlled by lowering the pressure of the interlacer in order to increase smoothness.

However, when the cohesion factor (or the combining factor) of the fiber is controlled by the pressure control, since a gap between a strong cohesive part and an incohesive part partially enlarges and the cohesion factor decreases, the occurrence of failing to catch some filament of bundle is caused in a winding process, and problems such as winding inferiority, deterioration of workability, deterioration of quality, and the like are caused, and the smoothness of the fiber is very irregular.

Particularly, when the cohesion factor decreases, a spread of fibers is caused by friction between the fibers and the machine during a warping and weaving process, and some filaments of the filament bundle are caught by a guide and some pin fibers and fluff are consequently generated. Therefore, irregularities in smoothness cause a difference in surface roughness of a coated product and consequently deteriorate the quality of the coated fabric.

### SUMMARY OF THE INVENTION

The present invention is for resolving such problems, and it is an objective of the present invention to provide a flat polyester fiber having good smoothness and a uniform structure with improved shrinkage stress and shrinkage rate.

It is another objective of the present invention to provide a fabric including the flat polyester fiber.

In order to attain the objectives, the present invention provides a polyester fiber wherein flatness of a cross-section thereof is from 2.0 to 4.0, a coefficient of variation (CV %) of R1 to R4 of the total filaments included therein is 20% or less when both end points of the longest axis of the cross-section of the fiber are defined as W1 and W2, both end points of the shortest axis perpendicularly crossing the longest axis at the center point O of the longest axis are defined as D1 and D2, a line between W1 and D1 is defined as L1, a line connected between D1 and W2 is defined as L2, a line between W1 and D2 is defined as L3, a line between W2 and D2 is defined as L4, perpendicular distances from L1, L2, L3, and L4 to the furthest line of the cross-section are defined as R1, R2, R3, and R4, respectively, and perpendicular distances from L1, L2, L3, and L4 to the center point O are defined as H1, H2, H3, and H4, respectively.

The present invention also provides a polyester fiber wherein flatness of the cross-section of the fiber is from 2.0 to 4.0, shrinkage stress (@ 0.1 g/d, 2.5°/sec) at 150° is from 0.005 to 0.075 g/d, shrinkage stress (@ 0.1 g/d, 2.5°/sec) at 200° is from 0.005 to 0.075 g/d, and shrinkage rate (@ 190°, 15 min, 0.01 g/d) is from 1.5 to 5.5%.

The present invention also provides a fabric including the polyester fiber.

### BRIEF DESCRIPTION OF THE DRAWINGS

FIG. 1 is a schematic drawing showing one example of the cross-section of the present polyester fiber.

FIG. 2 is a schematic process diagram showing the process of preparing the present polyester fiber.

FIG. 3 is a schematic plane drawing showing one example of the die used in the present spinning process.

FIG. 4 is a schematic drawing of a cross-section of the die used, showing a capillary of the die.

FIG. 5 is a schematic cross-sectional drawing showing one example of the spinning pack used in the present spinning process.

FIG. 6 is a bottom view drawing showing one example of the dispersing plate used in the present spinning process.

FIG. 7 is a cross-sectional drawing showing one example of the dispersing plate used in the present spinning process.

FIG. 8 is a schematic drawing showing an interlacer that provides interlacing air to the fiber in the direction perpendicular to the running direction of the fiber.

FIG. 9 is a schematic drawing showing an interlacer that provides interlacing air to the fiber in the inclined direction with respect to the running direction of the fiber.

FIG. 10 is a schematic process diagram showing a case of using a second interlacer and an after-oiling apparatus together.

FIG. 11 is an optical microscopic photograph showing the cross-section of the flat cross-sectional fibers prepared according to the present Example 1.

### DETAILED DESCRIPTION OF THE EMBODIMENTS

Hereinafter, the embodiments of the present invention will be described in more detail.

The present invention relates to a polyester fiber and a fabric including the same, wherein the fiber is suitable for preparing a coated fabric in which the fabric made of the fibers is thinner than the fabric made of common circular cross-sectional fibers, and its surface irregularity and porosity are low.

In comparison with prior methods of preparing industrial polyester fiber, the present invention is characterized in that the thickness, the surface irregularity, and the porosity of the fabric made of the fiber are lessened by making the cross-section of the fiber to be flat compared with prior circular by adopting slit-type capillaries in the die.

The present invention is also characterized in that the shape stability is optimized when the fiber is applied to fabrics such as coated transfer fabrics by managing the figural characteristics, the shrinkage stress, and the shrinkage rate of the fiber having a flat cross-section, and problems such as abnormal shrinkage are resolved.

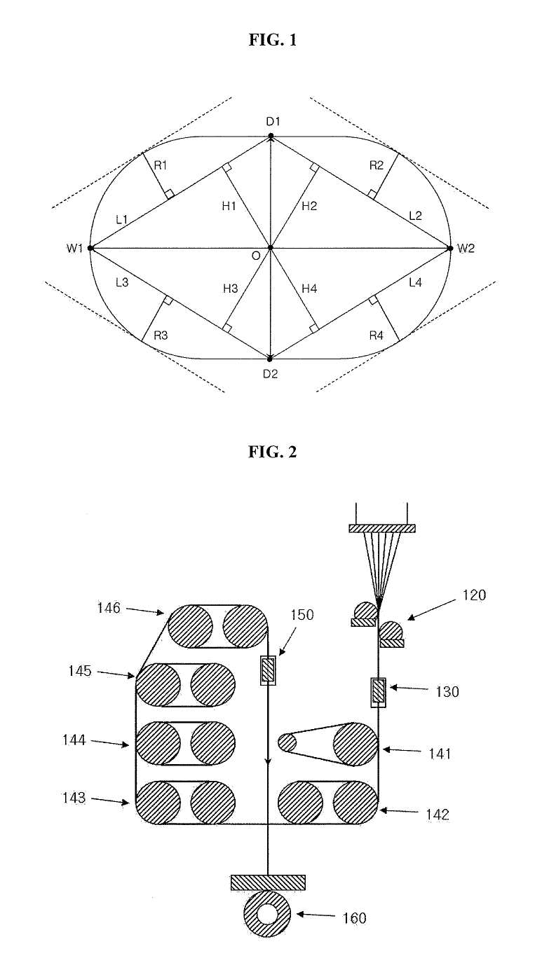

FIG. 1 is a schematic drawing showing one example of the cross-section of the present polyester fiber. As illustrated in FIG. 1, it is preferable that the flatness, which is defined as a ratio of the length of the longest axis (W1−W2)/the length of the shortest axis (D1−D2), is from 2.0 to 4.0.

Also, it is preferable that the coefficient of variation (CV %) of R1 to R4 is 20% or less, when both end points of the longest axis of the cross-section are defined as W1 and W2, both end points of the shortest axis perpendicularly cross the longest axis at the center point O of the longest axis are defined as D1 and D2, the line between W1 and D1 is defined as L1, the line between D1 and W2 is defined as L2, the line between W1 and D2 is defined as L3, the line between W2 and D2 is defined as L4, the perpendicular distances from L1, L2, L3, and L4 to the farthest line of the cross-section are defined as R1, R2, R3, and R4, respectively, and the perpendicular distances from L1, L2, L3, and L4 to the center point O are defined as H1, H2, H3, and H4, respectively, in FIG. 1.

When the coefficient of variation (CV %) is over 20%, the properties and the cross-sectional shape of the fiber become irregular, and the processing workability and the quality may be affected as fiber breakage, partial deformation of the shape, or distortion of the fiber occurs.

Furthermore, it is preferable that the average of the length ratios defined as R1/H1, R2/H2, R3/H3, and R4/H4 in the cross-section is from 0.2 to 0.9. The shoulder parts of the fiber become bulky as the average of the length ratio increases, and the shoulder parts of the fiber become thin and it has an oval or diamond-shaped cross-section as the average of the length ratio decreases.

Also, it is preferable that the coefficient of variation (CV %) of R1/H1, R2/H2, R3/H3, and R4/H4 is 20% or less so that the flat cross-sectional fiber have stable properties can be produced. That is, the shape of the cross-section is twisted when the coefficient of variation of R1/H1, R2/H2, R3/H3, and R4/H4 is over 20%, and the properties of the fiber and the smoothness of the fabric made of the fiber deteriorate.

Furthermore, it is preferable that the shrinkage stress at 150° C., which corresponds to a laminate coating temperature for general coated fabrics, is from 0.005 to 0.075 g/d, and it is also preferable that the shrinkage stress at 200° corresponding to a sol coating temperature for general coated fabrics is from 0.005 to 0.075 g/d. That is, when the shrinkage stresses at 150° and 200° are at least 0.005 g/d, respectively, drooping of the fabric caused by the heat of the coating process may be presented, and when the stresses are 0.075 g/d or less, relaxation stress can be relieved during a cooling process at room temperature after the coating process.

It is also preferable that the shrinkage rate of the polyester fiber at 190° is 1.5% or more in order to maintain the woven shape by providing tension of over a certain level during the heat treating of the coating process, and it is also preferable that the shrinkage rate at 190° is 5.5% or less in order to secure thermal shape stability.

The shrinkage stress defined in the present invention is based on a value measured under a fixed load condition of 0.0 g/d, and the shrinkage rate is based on a value measured under a fixed load condition of 0.01 g/d.

Said polyester fiber is preferably a polyethylene terephthalate (PET) fiber among general polyesters, and it is more preferably a PET fiber including PET at 90 mol % or more.

It is preferable that the intrinsic viscosity of the fiber is 0.7 dl/g or more so that the polyester fiber has the shrinkage stress of 0.005 g/d or more, and that the intrinsic viscosity is 1.2 dl/g or less, and more preferably 1.0 dl/g or less, in order to represent the low shrinkage property.

Furthermore, it is preferable that the fineness of the monofilament of the present polyester fiber having the specific shape is from 3.7 to 10.5 de, and it is also preferable that the tensile strength thereof is from 6.5 to 8.5 g/d and the elongation at break thereof is from 15 to 35% in order to secure the physical properties required as an industrial fiber.

In the preparing process of the polyester fiber, the present invention also has a characteristic in that it generates the following properties by providing interlacing air when the polyester fiber is passed through the pre-interlacer of the spinning process. Namely, it is preferable that the polyester fiber has fineness of the monofilament of 3.7 to 10.5 de which is equal to the fiber having the specific shape because an air having a direction in a certain range is provided to the pre-interlacer. Furthermore, the crystallinity is preferably 40% or more, and more preferably 42 to 52%, in order to maintain the thermal shape stability. Furthermore, the polyester fiber may have tensile strength of 6.5 to 8.5 g/d and elongation at break of 15 to 35%, intermediate elongation (84.5 g/d) of 6.5 to 17.5%, and a shape stability index (ES) of 12 to 23 in order to secure the physical properties required as an industrial fiber.

The polyester fiber of the present invention having the above properties has high yield of the process when it is made into a fabric and coated with a resin, and it is possible to prepare a fabric having good shape stability while decreasing the thickness of the fabric. The fabric includes a resin coating layer(s) including polyvinylchloride, polyethylene, polyurethane, and so on, which are coated or laminated on the surface of the fabric, and the kinds of the coated resin are not limited to the above-mentioned materials.

Since the flat cross-sectional fiber included in the fabric of the present invention is superior in packing property, and its thickness is thin and the area covered by the fiber itself is large in comparison with general circular cross-sectional fiber, the coated fabric of the present invention prepared from the fiber has advantages in that its thickness is thin, its pores are small, and its surface roughness is low, and thus it is possible to exhibit a superior coating property even with a small amount of the coating solution, and the inferior rate in the coating process is low when it is coated. Therefore, the fabric is very suitable for a transfer fabric of a signboard and the like.

The present polyester fiber having a flat cross-section may be prepared by melting polyester chips having an intrinsic viscosity of 0.7 to 1.2 dl/g at a spinning temperature of 270 to 310° and spinning it through slit-typed capillaries. The intrinsic viscosity of the chips is preferably 0.7 dl/g or more in order to prepare the fiber having desirable shrinkage stress and shrinkage rate, and the intrinsic viscosity is 1.2 dl/g or less in order to prevent breakage of the molecular chain due to the elevated melting temperature and the increase of the pressure in the spinning pack.

FIG. 2 is a schematic process diagram showing the process of preparing the present polyester fiber. As shown in FIG. 2, the preparing method of the present fiber includes the steps of cooling the molten polymer spun through the spinning die with quenching-air, providing an oil to the undrawn fiber by using an oiling roll (120) (or an oil-jet), and dispersing the oil provided to the undrawn fiber onto the surface of the fiber uniformly by using a pre-interlacer (130) with regular air pressure. After this, the drawing process is carried out by passing the undrawn fiber through the multi-step drawing apparatuses (141-146), and then the present fiber is finally produced by intermingling the drawn fiber with regular pressure in the second interlacer (150) and winding it with a winder (160).

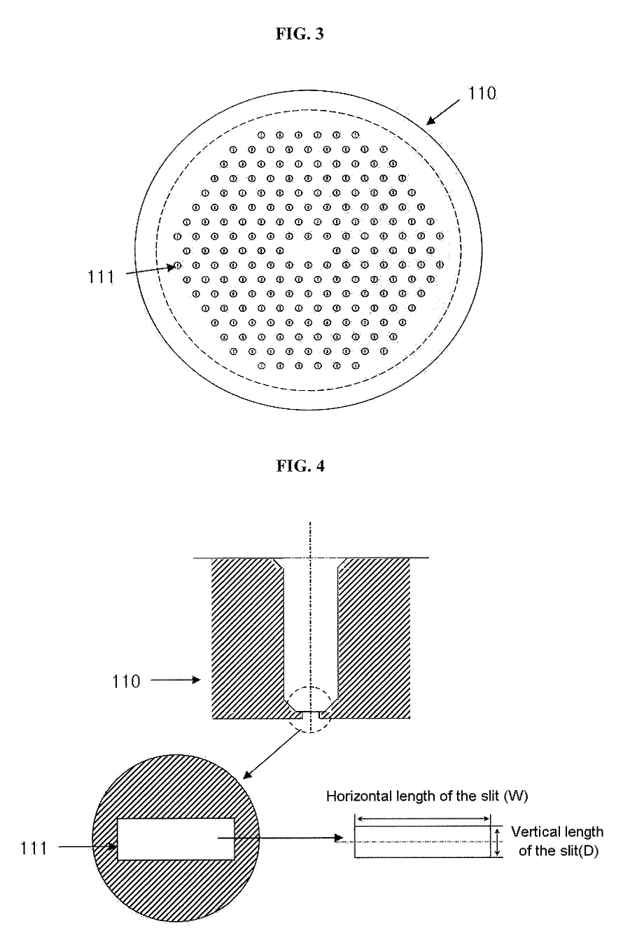

FIG. 3 is a schematic plane drawing showing one example of the die (110) that is used in the present spinning process. Referring to FIG. 3, a plurality of capillaries (111) are formed on the upper part of the present spinning die. The arranging type of the capillaries is not particularly limited, but it may preferably be a triangle type, a diamond type, or a circle type in which the capillaries are arranged with the same pitch of center distance (PCD).

FIG. 4 is a schematic drawing showing a capillary (111) of the die in a cross-sectional drawing of the die (110) used. As shown in FIG. 4, the cross-section of the discharged fibers becomes flat compared with prior circular by making the structure of the capillaries that discharge the liquefied polymer as a slit type.

In the shape of the slit of FIG. 4, the flatness can be particularly controlled by varying the ratio of the longest length (W) and the shortest length (D) of the slit, wherein the ratio of “W/D” is defined as a flatness of the die, and the flatness is preferably 5.0 or more in order to represent the characteristic of the flat cross-section and it is also preferably 15 or less in order to secure drawability and the high strength property.

Furthermore, the shear rate (sec⁻¹) that operates in the slit-typed die is preferably 1000 to 4500 sec⁻¹ in order to secure the uniform cross-section of the flat shape. When the shear rate is less than 1000 sec⁻¹, the cross-section becomes heterogeneous because the viscosity of the polymer seriously varies, and when it is over 4500 sec⁻¹, the spinning property may be poor because the viscosity excessively decreases.

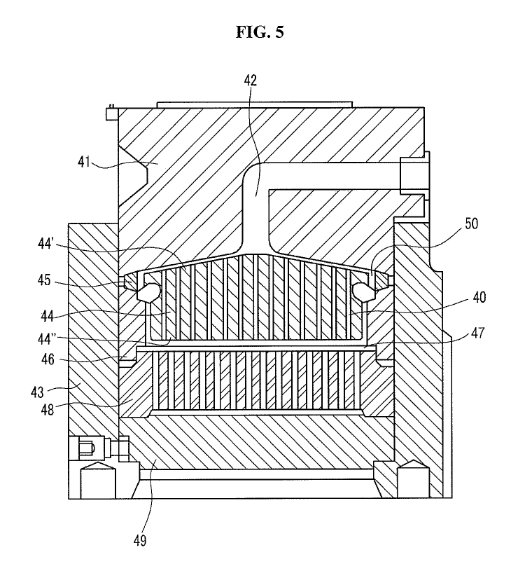

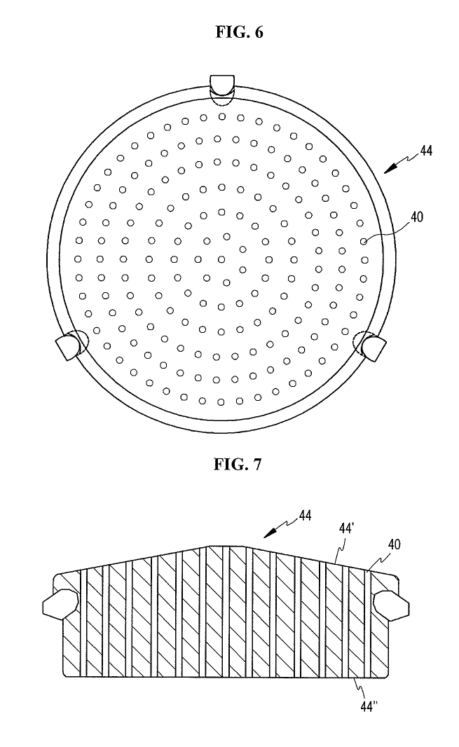

The spinning pack that spins the molten polymer into fibers is not particularly limited, but it is preferable to use a spinning pack having the construction as illustrated in FIG. 5. In the spinning pack apparatus applied to the present invention having the construction as illustrated in FIG. 5, a body (43) is connected to the lower part of a block (41) equipped with a polymer inlet (42), and, inside the body (43), a dispersing plate (44) having a dispersing surface (44′), a lens ring (45), a spacer (46), a filter (47) composed of a metal non-woven fabric, a dividing plate (48), and a die (49) are stacked in order in a state leading to the polymer inlet (42), and at least one polymer inflow hole (40) vertically perforated through the dispersing plate are formed on the dispersing plate (44) as shown in FIG. 6 and FIG. 7.

By maintaining the distance between the bottom (44″) of the dispersing plate (44) and the filter (47) at 4 to 44 mm, the stay time of the molten polymer passing through a polymer flowing path (50) of the outer side of the dispersing plate (44) and the stay time of the molten polymer passing through the polymer inflow holes (40) of the dispersing plate (44) may be maintained to be equal, and thus the total stay time may be shortened. The shape of the bottom (44″) of the dispersing plate (44) is also not particularly limited, but it may preferably be a plane-shape or a gentle cone-shape.

A polymer inflow hole is formed at the center of the dispersing plate, and the pitch of center diameter (PCD) between successive adjacent inflow holes is 5 to 40 mm, and it is preferable that the total area covered by the inflow holes per circle area covered by the outer line of the dispersing plate is 1 to 35%. It is very difficult to prepare a dispersing plate of which the PCD between the successive adjacent inflow holes is less than 5 mm, and the dispersibility of the polymer may deteriorate when the PCD is over 40 mm. Furthermore, when the total area covered by the inflow holes per total circle area of the dispersing plate is less than 1%, the dispersing plate cannot be applied to the present invention because deterioration of the dispersibility of the polymer and increase of pressure in the polymer spinning pack are caused, and when it is over 35%, the dispersing efficiency of the polymer in the spinning pack decreases.

While the molten polymer introduced into the polymer inlet (42) flows naturally down in accordance with the inclined angle of the cone-shaped dispersing surface (44′), a portion of the polymer flows into the polymer inflow holes (40) that are vertically perforated through the dispersing plate and the rest flows into the polymer flowing path (50) of the outer side, and the whole polymer is extruded through the filter (47), the dividing plate (48), and the die (49) in order and forms the fiber.

In the spinning pack apparatus of the present invention, when the molten polymer flows on the dispersing plate (44), the polymer flowing path (50) is farthest from the center peak of the dispersing surface (44′), whereas the length to the bottom (44″) of the dispersing plate (44) is shortest at the outer end of the dispersing surface (44′) because of the inclined angle of the dispersing plate (44′).

On the other hand, the polymer inflow holes (40) are closer to the center of the dispersing plate (44) than the polymer flowing path (50), whereas the distance to reach the bottom (44″) of the dispersing plate through the polymer inflow holes (40) is long.

Therefore, the stay time of the molten polymer reaching the dividing plate (48) through the polymer flowing path (50) and the stay time of the molten polymer reaching the dividing plate (48) through the polymer inflow holes (40) may be balanced and thus the total stay time may be shortened.

Furthermore, the filter (47) is a non-woven sintered metal fabric instead of metal powders in the spinning pack apparatus employed in the present invention, and thus a change of the fiber properties according to the passage of time can be prevented.

The dispersing plate (44) of the present invention can have one or more grooves formed around the outer circumference as occasion demands, and it is preferable that the grooves are arranged at the same intervals. The grooves make it easy to flow the molten polymer.

By applying the spinning pack having such construction, it is possible to make the fluidity of the polymer in the spinning pack uniform, and it is also possible to improve the spinning property according to the high pressure spinning because the pack raises the rear pressure of the die.

The polymer extruded from the die is quenched through a delayed quenching zone that is composed of a combination of a hood-heater (H/H) and a heat insulating plate in order to lower the spinning tension and lessen the thermal history. At this time, the temperature of the hood-heater (H/H) is preferably 200 to 350° and its length is preferably 100 to 400 mm, and the length of the heat insulating plate is preferably 70 to 400 mm. The stay time of the extruded polymer in the delayed quenching zone is preferably 0.01 to 0.1 sec., and more preferably 0.02 to 0.08 sec.

When the temperature of the hood-heater is less than 200° and its length is less than 100 mm, the drawability deteriorates and the spinning becomes difficult, and when the temperature is over 350° and the length is over 400 mm, the tenacity deteriorates because the degradation of the polyester occurs, and the stability of the flat shape falls because the elasticity of the molten polyester decreases. Furthermore, when the length of the heat insulating plate is less than 70 mm, fluff is generated because the drawability falls, and when the length is over 400 mm, the spinning tension decreases rapidly and the winding becomes difficult because the solidifying point decreases excessively. When the stay time in the delayed quenching zone is less than 0.01 sec., it is difficult to carry out the delayed quenching and it is also difficult to secure the drawability because the birefringence index of the undrawn fiber is high, and when the time is over 0.1 sec., the operation is difficult owing to the generation of the fluff and the fiber breakage because of the generation of the fiber deviation and the vortex flow caused by the deterioration of the tension of the undrawn fiber extruded from the die, and it is also difficult to obtain the required cross-section of the fiber because of the excessive deterioration of the elasticity of the molten polyester.

The polyester fiber having undergone the quenching process is provided with a spinning oil by passing it through an oiling roller. Any one that is used in the process for preparing the common polyester fiber can be used, and preferably a spinning oil that is one or a mixture of two or more selected from an ethyleneoxide/propyleneoxide attached diol ester, an ethyleneoxide attached diol ester, a glyceryl triester, a trymethylpropane triester, or other ethyleneoxide adducts is used, and the spinning oil may further include an antistatic agent and the like. However, the kinds of the spinning oil of the present invention are not limited to the above examples.

The polyester fiber provided with the spinning oil is drawn through a drawing apparatus after passing through the pre-interlacer, and the drawing condition can follow the drawing method of the common polyester fiber.

Then, it is possible to pass the polyester fiber through the pre-interlacer as is, or it is also possible to selectively provide interlacing air having a direction in a certain range to the pre-interlacer.

When the interlacing air is provided to the pre-interlacer, the present invention provides the polyester fiber having the above-mentioned properties, and also makes it possible to provide a polyester fiber having particular properties in which the crystallinity is from 42 to 52%, the tensile strength is from 6.5 to 8.5 g/d, the elongation at break is from 15 to 35%, the intermediate elongation (@4.5 g/d) is 6.5 to 17.5%, and the shape stability index (ES) is from 12 to 23, through the post-drawing process explained hereinafter.

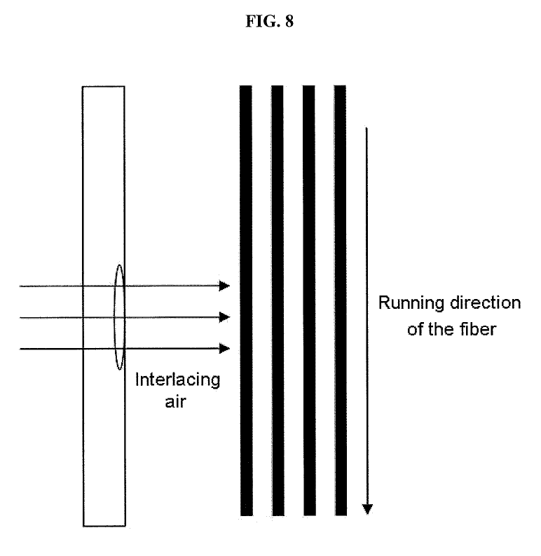

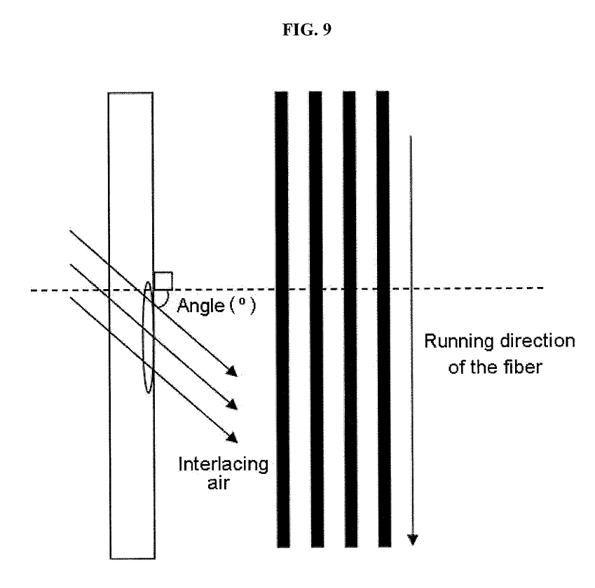

As the method to provide interlacing air to the pre-interlacer, it is possible to provide the interlacing air to the pre-interlacer in the direction perpendicular to the running direction of the fiber as illustrated in FIG. 8, and it is also possible to provide the interlacing air to the pre-interlacer in an inclined direction with respect to the running direction of the fiber as illustrated in FIG. 9. Since the cross-section of the undrawn fiber is flat, it is more preferable to provide the air to the pre-interlacer in the inclined direction with respect to the running direction of the fiber according to FIG. 9 in order to prevent the vortex flow of the undrawn fiber caused by the air, and it is most preferable that the direction of the interlacing air has an angle of 0° to 80° from the plane perpendicular to the running direction of the fiber.

Furthermore, it is preferable that the pressure of the interlacing air is 0.1 kg/cm² or more in order to gather the undrawn fiber in order and improve the drawability while migrating the oil provided to the undrawn fiber uniformly, and it is also preferable that the pressure is 1.5 kg/cm² or less in order to prevent the deterioration of the drawability caused by the excessive interlacing of the undrawn fiber.

In the spinning process, when the spinning speed is below 400 m/min, the quality of the fiber falls owing to fiber deviation, and when the speed is over 900 m/min, the workability is reduced because of the generation of the fluff.

Furthermore, the drawing ratio is preferably 4.5 to 6.2 times, because it is difficult to have the required property of the high tenacity when the drawing ratio of the spinning process is less than 4.5 times, and the quality of the fiber falls because of the generation of the fluff when the ratio is over 6.2 times. The drawing process of the present invention is accomplished by pre-drawing that is carried out between the apparatuses 141 and 142 of FIG. 2, the first drawing step that is carried out between the apparatuses 142 and 143, and the second drawing step that is carried out between the apparatuses 143 and 144 in order to secure the uniform drawability between the monofilaments, and the drawing ratio of the pre-drawing is preferably 1.01 to 1.1 and the drawing ratio of the first drawing step is preferably 60 to 85% of the total drawing ratio.

When the temperature of the heat treating carried out at the drawing apparatus 144 is less than 215°, the shape stability deteriorates because of the increase of the shrinkage rate, and when the temperature is over 250°, the fiber breakage and tar on the godet rollers appears frequently and the workability decreases. Therefore, the heat treating temperature is preferably 215 to 250°, and more preferably 230 to 245°.

When the relaxing rate of the drawing process carried out at the multi-step drawing apparatus 144 to 146 is less than 4%, the cross-section of the fiber may be distorted by the excessive tension, and when it is over 13%, the working is difficult because the fiber deviation occurs excessively at the godet rollers. Therefore, the relaxing rate is preferably 4 to 13% and the relaxing temperature is preferably 150 to 245°.

Furthermore, the present invention makes it possible to interlace the fiber by applying the second interlacer to the drawn polyester fiber again.

The second interlacer intermingles the polyester fiber by using the air pressure. The second interlacer improves the deterioration of the cohesion factor according to the decrease of air pressure of a usual interlacer, and performs a role to intermingle uniformly along the length direction (or the running direction) of the fiber.

The second interlacer may be located alone or together beyond the winder or between the godet rollers (correspond to 141 to 146 of FIG. 2), which are the drawing apparatuses, the interlacing air must be provided in the inclined direction to the running direction of the fibers as illustrated in FIG. 9, and it is preferable that the direction of the interlacing air has an angle of 20° to 80° from the plane perpendicular to the running direction of the fiber. At this time, the air pressure is also preferably 0.1 to 4 kg/cm².

When the air pressure is less than 0.1 kg/cm², it is insufficient to provide the fiber with the cohesion factor, and consequently it causes a decrease of the combining factor, disorder of winding, and generation of the fluff. Furthermore, when the air pressure is over 4.0 kg/cm², there are too many strong intermingles between the filaments of the fiber (or too big CFP (Cohesion Factor by Pin)) it is difficult to obtain the required smoothness, and the degree of irregularity in regard to the length direction of the fiber is large.

The second interlacer can be applied continuously with multi-steps in order to increase the number of micro-intermingles. In case of the multi-steps, the interlacer is preferably equipped with 2 ea or more, more preferably 2 to 4 ea, continuously. When the second interlacer is equipped with multi-steps, it is preferable that the number of steps of the multi-interlacer is at most 4 ea, because its installation is difficult and the workability decreases when the number of multi-steps of the interlacer is 5 ea or more.

The polyester fiber having passed through the second interlacer is wound by a winder, and then the polyester fiber of the present invention is finally prepared.

Furthermore, the present method of the polyester fiber may further include a process of providing after-oil by equipping an after-oiling apparatus between the second interlacer and the winder in order to improve the workability of the post-process by improving the antistatic property and the cohesion factor of the fiber.

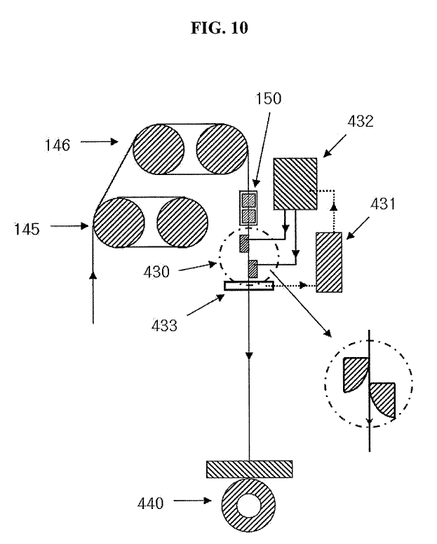

FIG. 10 is a schematic process diagram showing a case of applying the second interlacer with multi-steps of two or more steps and using an after-oiling apparatus together. As shown in FIG. 10, the second interlacer (150) is located after the drawing apparatuses (145, 146) of the polyester fiber. Also, the after-oiling apparatus (430) is a jet-guide type and is installed up and down or right and left with respect to the running direction of the fiber, and it performs a role of applying the after-oil to the fiber.

As an auxiliary apparatus of the after-oiling apparatus, an oil bath (431) for keeping the after-oil, a metering-pump (432) for sending the oil to the after-oiling apparatus in a fixed quantity, and an oil collecting bath (433) that collects oil having dripped from the after-oiling apparatus, transfers and recirculates the oil to the oil bath, and performs a role of antipollution and the like of the winder (440) are included.

The amount of oil provided in the after-oiling process is preferably 0.1 to 2.0 wt % of the weight of the polyester fiber. When the amount of oil is less than 0.1 wt %, the improving effect of the cohesion factor and the antistatic property required of the polyester fiber is insignificant, and when the amount is over 2.0 wt %, contamination by the oil may occur and it may also reduce the adhesive strength when it is applied to a coated fabric.

After-oils for the normal polyester fiber can be used as the present after-oil. The after-oil is distinguished from the oil provided before the drawing process, and an after-oil containing a polyol-polyalkylate as the main component, a polyoxyethylene alkyl ether, an antioxidant, an antistatic agent, and the like may be used.

The preparation method of the present invention may further apply tension guides after the relaxing process (between 145 to 146 in FIG. 2) in order to prevent overlapping of the monofilaments caused by fiber deviation during the relaxing process (between 144 and 146 in FIG. 2).

Hereinafter, preferable examples of the present invention are presented. However, the following examples are only for illustrating the present invention and the present invention is not limited to or by them.

### EXAMPLES

### Examples 1 to 7

Solid state polymerized polyester chips having intrinsic viscosity (IV) of 0.85 g/dL were melted and extruded through slit-shaped spinning capillaries.

Delayed quenching of the extruded molten polyester was carried out by passing through a delayed quenching zone composed of a hood-heater and a heat insulating plate.

The quenched polyester fiber was provided with spinning oil by using a roll-shaped oiling apparatus. At this time, the amount of oil was 0.8 parts by weight per 100 parts by weight of the fiber, and the spinning oil, in which an ethylene oxide/propylene oxide attached diol ester (30 parts by weight), an ethylene oxide attached diol ester (15 parts by weight), a glyceryl triester (10 parts by weight), a trimethyl propane triester (10 parts by weight), and a small quantity of an antistatic agent were mixed, was used.

The fiber provided with the oil was passed through the pre-interlacer and drawn by godet rollers.

After the drawing, the drawn fiber was intermingled by a second interlacer and the polyester fiber was finally prepared by winding it with a winder.

The conditions of the examples of the present invention, such as the shape and the flatness of the capillaries of the spinning die, the shear rate (sec⁻¹) at the die, the construction of the applied spinning pack, the temperature and length of the hood-heater, the length of the heat insulating plate, the stay time at the delayed quenching zone, the spinning speed, the relaxing rate, the temperature of the heat treating, and so on, are listed in the following Table 1. Furthermore, the shape of the spinning pack is not particularly limited, but the polyester fiber a preferably prepared by applying the spinning pack having the shape of FIG. 5.

### Comparative Example 1

The polyester fiber was prepared according to several conditions of the following Table 1.

TABLE 1

| | | | | | | | | Comparative |
|---|---|---|---|---|---|---|---|---|
| | Examples | | | | | | | Example |
| | 1 | 2 | 3 | 4 | 5 | 6 | 7 | 1 |
| IV of chips | 0.85 | 1.15 | 0.95 | 1.01 | 0.90 | 0.85 | 0.90 | 0.85 |
| (dl/g) | | | | | | | | |
| Capillary shape of | Slit | Slit | Slit | Slit | Slit | Slit | Slit | Circle |
| the die | | | | | | | | |
| Die shear-rate | 2326 | 1260 | 3192 | 3210 | 3192 | 4073 | 2185 | 2022 |
| (sec⁻¹) | | | | | | | | |
| Die flatness | 8 | 5 | 15 | 10 | 10 | 10 | 8 | 1 |
| H/H Temperature + | 250 | 350 | 210 | 300 | 280 | 280 | 300 | 250 |
| 20 (□) | | | | | | | | |
| H/H Length | 300 | 200 | 100 | 300 | 300 | 400 | 300 | 300 |
| (mm) | | | | | | | | |
| Heat insulating | 70 | 300 | 70 | 70 | 400 | 100 | 70 | 70 |
| plate length | | | | | | | | |
| (mm) | | | | | | | | |
| Stay time in the | 0.037 | 0.067 | 0.015 | 0.044 | 0.049 | 0.055 | 0.037 | 0.037 |
| delayed zone | | | | | | | | |
| (sec.) | | | | | | | | |
| Spinning speed | 600 | 450 | 700 | 500 | 850 | 550 | 600 | 600 |
| (m/min) | | | | | | | | |
| Drawing ratio | 5.5 | 6.0 | 5.3 | 5.6 | 4.7 | 5.6 | 5.4 | 5.5 |
| (times) | | | | | | | | |
| Relaxing rate | 8.0 | 11.5 | 7.5 | 6.5 | 5.0 | 9.0 | 12.0 | 9.0 |
| (%) | | | | | | | | |
| Heat treating | 240 | 247 | 247 | 240 | 230 | 240 | 220 | 245 |
| temperature + | | | | | | | | |
| 20 | | | | | | | | |
| (□) | | | | | | | | |
| Relaxing | 220 | 240 | 200 | 160 | 180 | 220 | 240 | 240 |
| temperature + | | | | | | | | |
| 20 | | | | | | | | |
| (□) | | | | | | | | |
| Fineness of the | 5.2 | 4.4 | 5.0 | 10.4 | 5.2 | 5.2 | 5.2 | 5.2 |
| monofilament | | | | | | | | |

### Experimental Example 1

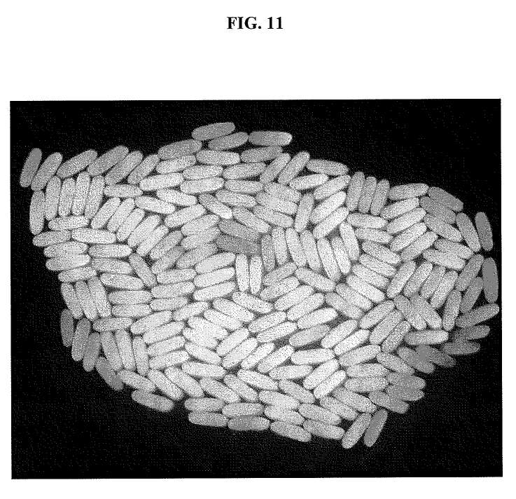

With regard to the polyester fiber prepared according to Examples 1 to 7 and Comparative Example 1, the flatness, the shrinkage stress, the shrinkage rate, the intrinsic viscosity, the tensile strength, the elongation at break, the cross-sectional shape index of the fiber (R1, H1, R1/H1, and CV %), the yield of the post-process, the processing workability (F/D), and the thickness of the coated fabric were measured by the following methods. The measured properties of each fiber are listed in the following Table 2, and a cross-sectional photograph of the flat fiber prepared according to Example 1 is illustrated in FIG. 11.

1) Flatness

Flatness represents the planiform degree of the cross-section of the fiber, and the flatness of the fiber was obtained by cutting the fiber with a copperplate, magnifying the cross-section with an optical microscope and measuring the longest length (W) and the shortest length (D) of the cross-section of the fiber, and calculating the flatness of monofilament according to the following Calculation Formula 1 and taking an average of the total filaments.

The flatness of monofilament (Fᵢ)=W/D,

The flatness of the fiber=(The sum of the flatness of monofilament)/(number of the monofilament). [Calculation Formula 1]

2) Coefficient of Variation of R1, R2, R3, and R4 (CV %)

From the cross-sectional photograph of the fiber magnified by the optical microscope, R1, R2, R3, and R4 of the monofilament were measured as illustrated in FIG. 1 and their average and standard deviation were calculated according to the following Calculation Formula 2, and then the coefficient of variation (CV %) was obtained according to the following Calculation Formula 3.

Average (R)=The sum (R1+R2+R3+R4) of the total filaments/(4×n) [Calculation Formula 2]

wherein n is the total number of measured filaments, and R is the average value of R1, R2, R3, and R4 of the total filaments.

Coefficient of Variation (CV %)=Standard deviation (σ)/Average (R)×100 (%) [Calculation Formula 3]

3) Average and Standard Deviation of R1/H1, R2/H2, R3/H3, and R4/H4

R1, R2, R3, and R4, and H1, H2, H3, and H4 of FIG. 1 were measured from the cross-sectional photograph of the fiber magnified by the optical microscope, the average and the standard deviation of R1/H1, R2/H2, R3/H3, and R4/H4 of the total filaments were calculated according to the following Calculation Formula 4, and then the coefficient of variation (CV %) was obtained according to Calculation Formula 3.

Average (R/H)=The sum (R1/H1+R2/H2+R3/H3+R4/H4) of the total filaments/(4×n) [Calculation Formula 4]

wherein n is the total number of the measured filaments, and R/H is the average value of R1/H1, R2/H2, R3/H3, and R4/H4 of the total filaments.

4) Shrinkage Stress (g/d)

The shrinkage stress was measured by using a thermal stress tester (Kanebo Co.) at 150° and 200°, respectively, while elevating the temperature with a scan speed of 2.5°/sec under an initial load of 0.1 g/d. The specimen was prepared by knotting in the form of loop.

$$Thermal stress ( g \text{/} d ) = \frac{Measured Termal Stress ( g )}{Fineness of the Fiber ( d ) \times 2} \qquad [ Calculation Formula 5 ]$$

5) Shrinkage Rate (%)

The shrinkage rate is a value representing a percentage of the change of the length of the specimen by heat at a specific temperature, and it is defined according to the following Calculation Formula 6.

Shrinkage rate (%)={(L₀−L₁)/L₀}×100 [Calculation Formula 6]

wherein L₀ is the length of the specimen before the thermal shrinking, and L1 is the length of the specimen after the thermal shrinking.

After fixing the fiber under a regular load of 0.01 g/d, the shrinkage rate was measured by the Testrite MK-V (Testrite Co.), and the measuring condition was based on a state of being left under a load of 0.01 g/d at 190° for 15 minutes.

6) Intrinsic Viscosity of the Fiber

After extracting the spinning oil from the specimen with carbon tetrachloride and dissolving the specimen in ortho-chlorophenol at 160±2°, the viscosity of the specimen was measured in a capillary by using an automatic viscometer (Skyvis-4000) at a temperature of 25°, and the intrinsic viscosity (IV) of the fiber was calculated according to the following Calculation Formula 7.

Intrinsic Viscosity (IV)={(0.0242×Rel)+0.2634}×F [Calculation Formula 7]

wherein,

Rel=(seconds of solution×specific gravity of solution×viscosity coefficient)/(OCP viscosity), and

F=IV of the standard chip/average of three IV measured from the standard chip with standard action.

7) Tensile Strength (g/d), Elongation at Break (%)

The tensile strength and the elongation at break were measured by a universal testing machine (UTM, Instron Co.), and the length of the specimen was 250 mm, the extending speed was 300 mm/min., and the initial load was 0.05 g/d.

8) Processing Workability (F/D)

As an index representing the productivity of the fiber, the portion of the full-cheese doffing number to the total doffing number was calculated according to the following Calculation Formula 8.

$$F / D ( \% ) = \frac{Number of Full Cheese Doffing}{Number of Full Cheease Doffing + Number of Cheese Doffing} \times 100 \qquad [ Calculation Formula 8 ]$$

9) Number of Warper Fluffs (ea/10⁶ m)

The number of warper fluffs was calculated by converting the number of check times of a Fluff-Detector to 10⁶ m scale.

10) Yield of the Post-Process

The percentage of the normal products to the total input of the fibers was calculated according to the following Calculation Formula 9.

Yield of the post-process=quantity of normal products/total input of fibers×100 [Calculation Formula 9]

11) Thickness of the Coated Fabrics

After preparing fabrics from the polyester fibers prepared by Examples 1 to 7 and Comparative Example 1 with a common rapier weaving machine under the same conditions, 250 parts by weight of polyvinylchloride (PVC) was coated on 100 parts by weight of the polyester fabric so as to prepare the fabric coated by PVC.

After measuring the thickness of the fabric, the thickness (T) of fabrics prepared from the polyester fibers of Examples 1 to 7 was divided by the thickness (t) of the fabric prepared from the polyester fibers of Comparative Example 1, and the percentage thereof was calculated according to the following Calculation Formula 10.

Thickness of fabric (%, relative value)=T/t×100 [Calculation Formula 10]

TABLE 2

| | | | | | | | | Comparative |
|---|---|---|---|---|---|---|---|---|
| | Examples | | | | | | | Example |
| | 1 | 2 | 3 | 4 | 5 | 6 | 7 | 1 |
| Flatness | 3.1 | 2.1 | 3.8 | 3.2 | 3.2 | 3.0 | 2.8 | 1 |
| CV of R | 10.2 | 6.4 | 15.7 | 11.3 | 10.7 | 9.4 | 5.7 | — |
| (CV %) | | | | | | | | |
| Average of R/H | 0.62 | 0.41 | 0.88 | 0.78 | 0.72 | 0.65 | 0.70 | 0.41 |
| CV of R/H | 11.5 | 7.8 | 17.8 | 12.7 | 11.3 | 10.3 | 6.5 | — |
| (CV %) | | | | | | | | |
| Shrinkage stress + | 0.022 | 0.009 | 0.012 | 0.035 | 0.067 | 0.035 | 0.043 | 0.025 |
| 20 | | | | | | | | |
| (@150□, g/d) | | | | | | | | |
| Shrinkage stress + | 0.031 | 0.012 | 0.020 | 0.041 | 0.074 | 0.043 | 0.055 | 0.037 |
| 20 | | | | | | | | |
| (@200□, g/d) | | | | | | | | |
| Shrinkage rate | 2.7 | 1.8 | 3.6 | 4.3 | 5.5 | 3.5 | 4.7 | 3.0 |
| (%) | | | | | | | | |
| Intrinsic viscosity | 0.81 | 0.99 | 0.90 | 0.93 | 0.88 | 0.81 | 0.84 | 0.80 |
| (dl/g) | | | | | | | | |
| Tensile strength | 7.5 | 8.0 | 6.8 | 8.2 | 8.5 | 7.7 | 7.3 | 7.3 |
| (g/d) | | | | | | | | |
| Intermediate | 12.5 | 13.6 | 14.9 | 8.7 | 6.7 | 12.0 | 16.5 | 12.8 |
| elongation | | | | | | | | |
| (%) | | | | | | | | |
| Elongation at break | 23.5 | 25.7 | 26.8 | 20.5 | 17.5 | 22.5 | 33.0 | 25.6 |
| (%) | | | | | | | | |
| Shape stability index | 15.2 | 15.4 | 18.5 | 13.0 | 12.2 | 15.5 | 21.2 | 15.8 |
| (ES) | | | | | | | | |
| Workability | 99.7 | 99.8 | 97.8 | 98.1 | 98.6 | 94.3 | 95.4 | 98.5 |
| (F/D rate, %) | | | | | | | | |
| Number of warper | 0.5 | 0.2 | 1.2 | 1.1 | 1.5 | 1.8 | 1.6 | 2.0 |
| fluffs | | | | | | | | |
| (EA/10⁶ m) | | | | | | | | |
| Yield of the | 99.5 | 99.7 | 98.5 | 98.7 | 98.8 | 95.5 | 96.8 | 97.1 |
| post-process | | | | | | | | |
| (%) | | | | | | | | |
| Thickness of the | 85.3 | 92.0 | 72.0 | 82.1 | 84.2 | 87.5 | 88.5 | 100 |
| coated fabric | | | | | | | | |
| (%) | | | | | | | | |

As shown in Table 2, the present polyester fibers prepared according to Examples 1 to 7 are not only superior in thermal shape stability owing to the low shrinkage stress and low shrinkage rate, but are also superior in the properties of the fibers owing to the uniformity of the flat shape of the cross-section of the fibers. Also, they show processing workability and quality (level of fluff) equal to those of the conventional polyester fiber having the circular cross-section prepared according to Comparative Example 1, and it is possible to lessen the thickness of the coated fabric and contribute to lessening the weight of the product and improving the surface smoothness.

### Examples 8 to 14 and Comparative Example 2

Solid state polymerized polyester chips having the intrinsic viscosity (IV) of 0.85 g/dL were melted and extruded through the slit-shaped spinning capillaries.

The delayed quenching of the extruded molten polyester was carried out by passing through the delayed quenching zone composed of the hood-heater and the heat insulating plate.

The quenched polyester fiber was provided with spinning oil by using the roll-shaped oiling apparatus. At this time, the amount of oil was 0.8 parts by weight per 100 parts by weight of the fiber, and the spinning oil, in which an ethylene oxide/propylene oxide attached diol ester (30 parts by weight), an ethylene oxide attached diol ester (15 parts by weight), a glyceryl triester (10 parts by weight), a trimethyl propane triester (10 parts by weight), and a small quantity of an antistatic agent were mixed, was used.

The fiber provided with the oil was passed through the pre-interlacer of FIG. 9 and drawn by the godet rollers.

After the drawing, the drawn fiber was intermingled by using the second interlacer of FIG. 9.

After-oil was provided to the polyester fiber having passed through the interlacer by using the after-oiling apparatus of a jet-guide type. At this time, the amount of after-oil was 0.7 parts by weight per 100 parts by weight of the fiber, and the after-oil, in which a polyol-polyalkylate (70 parts by weight), a polyoxyethylene alkylether (20 parts by weight), an antioxidant (2 parts by weight), and an antistatic agent (2 parts by weight) were mixed, was used.

After the after-oiling process, the polyester fiber was finally prepared by winding it with the winder

The conditions of the examples of the present invention, such as the shape and flatness of the capillaries of the spinning die, the temperature and length of the hood-heater, the length of the heat insulating plate, the stay time at the delayed quenching zone, the direction and the pressure of the air of the pre-interlacer, the spinning speed, the drawing ratio (the drawing ratio of the pre-drawing, and the drawing rate of the 1^{st} step of drawing compared to the total drawing ratio), the relaxing rate, the temperature of the heat treating, the number of the second interlacer, the direction and the pressure of the air, provision or not of the oil and the after-oil, and so on, are listed in the following Table 3.

The direction of the air of the interlacer means the angle of the jetted air based on the perpendicular direction with respect to the running direction of the fiber as illustrated in FIG. 9. That is, 0° means perpendicular to the running direction of the fiber, and 90° means parallel with the running direction of the fiber.

TABLE 3

| | | | | | | | | Comparative |
|---|---|---|---|---|---|---|---|---|
| | Examples | | | | | | | Example |
| | 8 | 9 | 10 | 11 | 12 | 13 | 14 | 2 |
| IV of chips | 0.85 | 1.15 | 0.95 | 1.01 | 0.90 | 0.85 | 0.90 | 0.90 |
| (dl/g) | | | | | | | | |
| Capillary shape of | Slit | Slit | Slit | Slit | Slit | Slit | Slit | Circle |
| the die | | | | | | | | |
| Die flatness | 8 | 5 | 15 | 10 | 10 | 10 | 8 | 1 |
| H/H Temperature + | 250 | 350 | 210 | 300 | 280 | 280 | 300 | 300 |
| 20 | | | | | | | | |
| (□) | | | | | | | | |
| H/H Length | 300 | 200 | 100 | 300 | 300 | 400 | 300 | 300 |
| (mm) | | | | | | | | |
| Heat insulating | 70 | 300 | 70 | 70 | 400 | 100 | 70 | 70 |
| plate length | | | | | | | | |
| (mm) | | | | | | | | |
| Stay time in the | 0.037 | 0.067 | 0.015 | 0.044 | 0.049 | 0.055 | 0.037 | 0.037 |
| delayed zone | | | | | | | | |
| (sec) | | | | | | | | |
| Air direction of the | 45 | 60 | 80 | 30 | 60 | 0 | 0 | 60 |
| pre-interlacer | | | | | | | | |
| (°) | | | | | | | | |
| Air pressure of the | 0.7 | 1.0 | 1.4 | 0.4 | 0.8 | 0.7 | 0.4 | 0.7 |
| pre-interlacer | | | | | | | | |
| (kg/cm²) | | | | | | | | |
| Spinning speed | 600 | 450 | 700 | 500 | 850 | 550 | 600 | 600 |
| (m/min) | | | | | | | | |
| Drawing ratio | 5.5 | 6.0 | 5.3 | 5.6 | 4.7 | 5.6 | 5.4 | 5.5 |
| (times) | | | | | | | | |
| Pre-drawing ratio | 1.02 | 1.08 | 1.03 | 1.02 | 1.02 | 1.05 | 1.02 | 1.02 |
| (times) | | | | | | | | |
| The 1^{st} drawing rate | 71 | 62 | 76 | 79 | 78 | 69 | 74 | 74 |
| compared to the | | | | | | | | |
| total drawing ratio | | | | | | | | |
| (%) | | | | | | | | |
| Relaxing rate | 8.0 | 11.5 | 7.5 | 6.5 | 5.0 | 9.0 | 12.0 | 8.0 |
| (%) | | | | | | | | |
| Heat treating | 240 | 247 | 247 | 240 | 230 | 240 | 220 | 240 |
| temperature + | | | | | | | | |
| 20 | | | | | | | | |
| (□) | | | | | | | | |
| Relaxing | 220 | 240 | 200 | 160 | 180 | 220 | 240 | 220 |
| temperature + | | | | | | | | |
| 20 | | | | | | | | |
| (□) | | | | | | | | |
| Number of 2^{nd} | 1 | 2 | 2 | 1 | 3 | 2 | 1 | 1 |
| interlacer | | | | | | | | |
| Air direction of the | 80 | 60 | 80 | 30 | 60 | 0 | 60 | 60 |
| 2^{nd} interlacer | | | | | | | | |
| (°) | | | | | | | | |
| Air pressure of the | 3.5 | 0.8 | 2.0 | 1.0 | 0.5 | 2.0 | 0.8 | 2.5 |
| 2^{nd} interlacer | | | | | | | | |
| (kg/cm²) | | | | | | | | |
| Provision or not of | Applied | Not | Applied | Applied | Not | Applied | Applied | Applied |
| the after-oil | | applied | | | applied | | | |
| Content of | 0.7/ | 0/ | 0.3/ | 1.2/ | 0/ | 1.7/ | 0.7/ | 0.7/0.8 |
| after-oil/oil | 0.8 | 0.8 | 0.8 | 0.8 | 0.8 | 0.8 | 0.8 | |
| (parts by weight) | | | | | | | | |
| Fineness of the | 5.2 | 4.4 | 5.0 | 10.4 | 5.2 | 5.2 | 5.2 | 5.2 |
| monofilament | | | | | | | | |

### Experimental Example 2

With regard to the polyester fibers prepared according to Examples 8 to 14 and Comparative Example 2, the flatness, the shrinkage stress, the shrinkage rate, the intrinsic viscosity, the tensile strength, the elongation at break, the processing workability, the number of warper fluffs, and the thickness of the coated fabric were measured according to the above methods. Furthermore, the crystallinity, the intermediate elongation, and the shape stability index were measured by the following methods. The measured properties are listed in the following Table 4, and a cross-sectional photograph of the flat fiber prepared according to Example 8 was obtained as in FIG. 11.

12) Crystallinity (%)

The density ρ of the fiber was measured according to the density gradient method using n-heptane and carbon tetrachloride at 25°, and the crystallinity was calculated according to the following Calculation Formula 11.

$$Xc ( crystallinity ) = \frac{{ρ}_{c} ( ρ - {ρ}_{a} )}{ρ ( {ρ}_{c} - {ρ}_{a} )} \qquad [ Calculation Formula 11 ]$$

wherein ρ is the density of the fiber, ρ_{c} is the density of a crystalline region (1.457 g/cm³ in case of PET), and ρₐ is the density of a amorphous region (1.336 g/cm³ in case of PET).

13) Intermediate Elongation (%) and Shape Stability Index

The intermediate elongation was based on the value corresponding to the stress of 4.5 g/d in the stress-strain curve measured by the UTM. The shape stability index (ES) was calculated according to the following Calculation Formula 12 based on the shrinkage rate measured under the load of 0.01 g/d at 190° C. for 15 minutes with Testrite MK-V.

Shape Stability Index (Es)=Intermediate Elongation+Shrinkage Rate [Calculation Formula 12]

14) Thickness of the Coated Fabrics

After preparing fabrics from the polyester fibers prepared by Examples 8 to 14 and Comparative Example 2 with a common rapier weaving machine under the same conditions, 250 parts by weight of polyvinylchloride (PVC) was coated on 100 parts by weight of the polyester fabric so as to prepare the fabric coated by PVC. After measuring the thickness of the fabric, the thickness (T) of the fabric prepared from the polyester fibers of Examples 8 to 14 was divided by the thickness (t) of the fabric prepared from the polyester fibers of Comparative Example 2, and the percentage thereof was calculated according to the following Calculation Formula 13.

Thickness of the fabric (%, relative value)=T/t×100 [Calculation Formula 13]

TABLE 4

| | | | | | | | | Comparative |
|---|---|---|---|---|---|---|---|---|
| | Examples | | | | | | | Example |
| | 8 | 9 | 10 | 11 | 12 | 13 | 14 | 2 |
| Flatness | 3.0 | 2.0 | 3.8 | 3.3 | 3.3 | 3.0 | 2.8 | 1 |
| Crystallinity | 46.5 | 51.0 | 47.1 | 45.2 | 42.7 | 45.4 | 43.3 | 44.3 |
| (%) | | | | | | | | |
| Shrinkage stress + | 0.020 | 0.007 | 0.015 | 0.033 | 0.065 | 0.032 | 0.042 | 0.018 |
| 20 | | | | | | | | |
| (@150□, g/d) | | | | | | | | |
| Shrinkage stress + | 0.030 | 0.010 | 0.022 | 0.039 | 0.070 | 0.041 | 0.054 | 0.027 |
| 20 | | | | | | | | |
| (@200□, g/d) | | | | | | | | |
| Shrinkage rate | 2.8 | 1.6 | 3.5 | 4.1 | 5.5 | 3.3 | 4.5 | 2.4 |
| (%) | | | | | | | | |
| Intrinsic viscosity | 0.77 | 0.99 | 0.88 | 0.91 | 0.86 | 0.80 | 0.85 | 0.83 |
| (dl/g) | | | | | | | | |
| Tensile strength | 7.3 | 7.8 | 6.7 | 8.0 | 8.4 | 7.6 | 7.2 | 7.6 |
| (g/d) | | | | | | | | |
| Elongation at break | 24.2 | 26.4 | 27.2 | 22.5 | 20.1 | 23.7 | 33.1 | 24.7 |
| (%) | | | | | | | | |
| Intermediate | 13.5 | 14.8 | 15.2 | 12.2 | 8.5 | 12.8 | 16.8 | 12.9 |
| elongation | | | | | | | | |
| (%) | | | | | | | | |
| Shape stability | 16.3 | 16.4 | 18.7 | 16.3 | 14.0 | 16.1 | 21.3 | 15.3 |
| index (ES) | | | | | | | | |
| Workability | 96.2 | 99.5 | 97.2 | 97.5 | 97.4 | 92.3 | 94.1 | 88.7 |
| (F/D rate, %) | | | | | | | | |
| Number of warper | 1.6 | 0.7 | 1.3 | 1.2 | 1.5 | 2.1 | 1.9 | 4.1 |
| fluffs | | | | | | | | |
| (EA/10⁶ m) | | | | | | | | |
| Yield of the | 98.1 | 99.1 | 98.4 | 98.5 | 98.2 | 95.0 | 97.2 | 89.1 |
| post-process | | | | | | | | |
| (%) | | | | | | | | |
| Thickness of the | 86.4 | 92.5 | 75.0 | 83.2 | 84.5 | 88.3 | 89.2 | 97.3 |
| coated fabric | | | | | | | | |
| (%) | | | | | | | | |

As shown in Table 4, since the present polyester fibers prepared according to Examples 8 to 14 are superior in thermal shape stability owing to the low shrinkage stress and low shrinkage rate, the distortion by heat applied during the post-process is less, and they show processing workability and quality (level of the fluff) equal to those of the conventional polyester fiber having the circular cross-section prepared according to Comparative Example 2, and in addition, it is possible to lessen the thickness of the coated fabric and contribute to lessening the weight of the product and improving the surface smoothness.

The polyester fiber of the present invention maximizes the surface smoothness by making the cross-section of the filaments flat and uniform, and there are advantages in that the fabric made of the present fibers is thinner than the fabric made of the circular cross-sectional fibers and it is possible to reduce the amount of the coating resin used and to lighten the weight of the product because of the low surface irregularity and the porosity.

1. A polyester fiber, wherein flatness of a cross-section thereof is from 2.0 to 4.0 and a coefficient of variation (CV %) of R1 to R4 of total filaments included therein is 20% or less, wherein both end points of the longest axis of the cross-section are defined as W1 and W2, both end points of the shortest axis perpendicularly crossing the longest axis at a center point O of the longest axis are defined as D1 and D2, a line between W1 and D1 is defined as L1, a line between D1 and W2 is defined as L2, a line between W1 and D2 is defined as L3, a line between W2 and D2 is defined as L4, a perpendicular distances from L1, L2, L3, and L4 to the farthest line of the cross-section are defined as R1, R2, R3, and R4, respectively, and a perpendicular distances from L1, L2, L3, and L4 to the center point O are defined as H1, H2, H3, and H4, respectively.

2. The polyester fiber according to claim 1, wherein the average of R1/H1, R2/H2, R3/H3, and R4/H4 of the total filaments included therein is 0.2 to 0.9.

3. The polyester fiber according to claim 1, wherein the coefficient of variation (CV %) of R1/H1, R2/H2, R3/H3, and R4/H4 of the total filaments included therein is 20% or less.

4. The polyester fiber according to claim 1, wherein shrinkage stress (@ 0.1 g/d, 2.5° C./sec) at 150° C. is from 0.005 to 0.075 g/d, shrinkage stress ((0.1 g/d, 2.5° C./sec) at 200° C. is from 0.005 to 0.075 g/d, and shrinkage rate (@ 190° C., 15 min, 0.01 g/d) is from 1.5 to 5.5%.

5. The polyester fiber according to claim 1, including polyethylene terephthalate (PET) in an amount of 90 mol % or more.

6. The polyester fiber according to claim 5, wherein the intrinsic viscosity is from 0.7 to 1.0 dl/g.

7. The polyester fiber according to claim 1, wherein the tensile strength is from 6.5 to 8.5 g/d and the elongation at break is from 15 to 35%.

8. The polyester fiber according to claim 1, wherein the fineness of the monofilament is from 3.7 to 10.5 de.

9. A polyester fiber, wherein flatness of the cross-section thereof is from 2.0 to 4.0, shrinkage stress (@ 0.1 g/d, 2.5° C./sec) at 150° C. is from 0.005 to 0.075 g/d, shrinkage stress (@ 0.1 g/d, 2.5° C./sec) at 200° C. is from 0.005 to 0.075 g/d, and shrinkage rate (@ 190° C., 15 min, 0.01 g/d) is from 1.5 to 5.5%.

10. The polyester fiber according to claim 9, including polyethylene terephthalate (PET) in an amount of 90 mol % or more.

11. The polyester fiber according to claim 9, wherein the intrinsic viscosity is from 0.7 to 1.0 dl/g.

12. The polyester fiber according to claim 9, wherein the crystallinity is from 42 to 52%.

13. The polyester fiber according to claim 9, wherein the tensile strength is from 6.5 to 8.5 g/d, the elongation at break is from 15 to 35%, the intermediate elongation (@ 4.5 g/d) is 6.5 to 17.5%, and the shape stability index (ES) is from 12 to 23.

14. A fabric comprising the polyester fiber according to claim 1.

15. The fabric according to claim 14, comprising one or more resin layers coated or laminated on the surface thereof.
